(19) United States
(12) Patent Application Publication
(10) Pub. No.: US 2024/0191566 A1
(43) Pub. Date: Jun. 13, 2024

(54) QUICKLY-ASSEMBLED ELECTRIC SUNSHADE CURTAIN

(71) Applicant: NINGBO SUNFREE MOTOR TECHNOLOGY COMPANY LIMITED, Ningbo City (CN)

(72) Inventor: Chun JIANG, Ningbo City (CN)

(21) Appl. No.: 18/482,792

(22) Filed: Oct. 6, 2023

(30) Foreign Application Priority Data
Dec. 7, 2022 (CN) 202211567121.5

(51) Int. Cl. E06B 9/322; E06B 9/262; E06B 9/327

(52) U.S. Cl. CPC E06B 9/322; E06B 9/262; E06B 9/327; E06B 2009/3222

(57) ABSTRACT

A quickly-assembled electric sunshade curtain is provided, which comprising a curtain frame and a curtain body; an upper end of the curtain body is fixedly connected with the upper rail, and a lower end of the curtain body is connected with a movable cross beam, which slidably cooperates with the curtain frame along an opening and closing direction of the curtain body. A single output motor and a transmission rod are disposed inside the upper rail. The single output motor is in transmission cooperation with the transmission rod through a gear assembly. A belt assembly is disposed in the side rails respectively. The first end of the transmission rod is connected to the belt assembly at one side through a quick connector and the second end of the transmission rod is connected to the belt assembly at the other side. The disposal of the quick connector improves the assembly efficiency.

This application is based upon and claims priority to Chinese Patent Application No. 202211567121.5, filed on Dec. 7, 2022, the entire contents of which are incorporated herein by reference.

### TECHNICAL FIELD

The present disclosure relates to the technical field of electric sunshade curtains, and in particular to a quickly-assembled electric sunshade curtain.

### BACKGROUND

Electric sunshade curtains usually comprise a curtain frame at both sides of which a transmission belt is disposed respectively and on the top of which a drive motor is disposed to drive the transmission belts at both sides to rotate synchronously. An upper end of a curtain body inside the curtain frame is fixedly connected with the top of the curtain frame, and a lower end of the curtain body is connected to a movable cross beam. Both ends of the movable cross beam are connected to the belts at both sides. By synchronous rotation of the belts at both sides, the movable cross beam is driven to slide up and down along the curtain frame, thus opening and closing the curtain body. The electric sunshade curtains with this structure have extremely high requirements for a horizontality of the movable cross beam, bringing difficulty to the mounting work. If the movable cross beam is not horizontal after being assembled, it is easy to leak light. Traditionally, a dual-output shaft drive motor is adopted to drive the belts at both sides. The output shaft at one end of the drive motor is in direct transmission connection with an upper end of the belt at one side and the output shaft at the other end of the drive motor is connected to one transmission rod through a connection sleeve and then to an upper end of the belt at the other side. This assembly structure is very complex, and the connection sleeve is easy to slip and the transmissions at both ends may also generate error over a long time of use, leading to light leakage due to the non-horizontal movable cross beam. Further, the dual-output shaft drive motor has a high cost. For some commercially-available curtains on the market, a single output shaft drive motor is in transmission connection with the transmission rod through a gear assembly and then the transmission rod is connected to the belts at both sides. Although the single output shaft drive motor is low in cost, it is difficult for the movable cross beam to keep horizontal, leading to extremely easy light leakage. Because the transmission rods mostly are of a regular quadrangle or regular hexagon structure, there is an angle error of 90 or 60 degrees. After the belt at one side is connected, the belt at the other side will generate an angle error, and thus it is difficult to assemble the movable cross beam horizontally. During assembling process, it is required to adjust the belts at both sides with great care to enable the movable cross beam to be horizontally assembled. Thus, high requirements are made for the assembling personnel and the assembling work is also troublesome, difficult and time and labor-consuming.

### SUMMARY

For the current situations of the prior arts, the technical problem to be solved by the present disclosure is to provide a quickly-assembled electric sunshade curtain, which can be mounted with less labor and less time while a movable cross beam can be mounted horizontally, so as to avoid light leakage.

In order to address the above technical problem, the present disclosure provides the technical solution: there is provided a quickly-assembled electric sunshade curtain comprising a curtain frame enclosed by an upper rail, a lower rail, and two side rails. A curtain body is disposed inside the curtain frame. An upper end of the curtain body is fixedly connected with the upper rail, and a lower end of the curtain body is connected with a movable cross beam. The movable cross beam slidably cooperates with the curtain frame along an opening and closing direction of the curtain body. A single output motor and a transmission rod are disposed inside the upper rail. The single output motor is in transmission cooperation with the transmission rod through a gear assembly. The single output motor and the transmission rod are disposed up and down in parallel. A belt assembly is disposed in the side rails respectively. The belt assemblies are in transmission connection with the transmission rod and the movable cross beam. The transmission rod has opposed first end and second end. The first end of the transmission rod is connected to the belt assembly at one side through a quick connector and the second end of the transmission rod is connected to the belt assembly at the other side.

Furthermore, the belt assemblies comprise a drive wheel, a belt and a driven wheel. Two ends of the belt are sleeved on the drive wheel and the driven wheel respectively. The drive wheel is disposed at an upper end of the side rails and the driven wheel is disposed at a lower end of the side rails. The first end of the transmission rod is connected through the quick connector to the drive wheel of the belt assembly at one side, where the drive wheel is a first drive wheel. The second end of the transmission rod is connected to the drive wheel of the belt assembly at the other side, where the drive wheel is a second drive wheel. External splines are integrally formed on the first drive wheel. Internal splines cooperating with the external splines are disposed on one end of the quick connector, and a connection groove connected with the transmission rod is disposed on the other end of the quick connector. A connection hole connected with the transmission rod is disposed on the second drive wheel. The first drive wheel and the second drive wheel can rotate in synchronization with the transmission rod.

Furthermore, the single output motor is disposed at an end of the upper rail and is close to the first end of the transmission rod. The gear assembly comprises an input gear and an output gear. The input gear is in engagement transmission with the output gear. The output end of the single output motor is in transmission connection with the input gear, the first end of the transmission rod is in transmission cooperation with the output gear, and the output gear is in transmission cooperation with the first drive wheel.

Furthermore, the gear assembly further comprises at least one transitional gear. The transitional gear is engaged between the input gear and the output gear. The output gear and the first drive wheel are integrally formed.

Furthermore, a vibration damping assembly is connected between the output end of the single output motor and the input gear. The vibration damping assembly comprises an input head, an output head and a vibration damping sleeve. The input head is connected with the output end of the single output motor. The output head is connected with the input gear. The vibration damping sleeve is connected between the input head and the output head to prevent the input head from being in direct contact with the output head. The vibration damping sleeve is a flexible vibration damping sleeve.

Furthermore, symmetrically-disposed first protrusion blocks extend from an end of the input head facing toward the vibration damping sleeve, and symmetrically-disposed second protrusion blocks extend from an end of the output head facing toward the vibration damping sleeve. The vibration damping sleeve is provided with grooves for alternately inserting the first protrusion blocks and the second protrusion blocks. A length of the grooves is greater than a length of the first protrusion blocks and the second protrusion blocks.

Furthermore, both ends of the movable cross beam are fixedly connected to the belts at both sides through fixing pieces. The movable cross beam can rotate in synchronization with the belts at both sides.

Furthermore, a first mounting chamber, a second mounting chamber and a third mounting chamber are disposed in sequence inside the upper rail from top down. The first mounting chamber is used to mount the single output motor, the second mounting chamber is used to mount the transmission rod, and the third mounting chamber is used to mount an upper end of the curtain body. A positioning piece for limiting the single output motor is disposed at the opposed end of the output end of the single output motor inside the first mounting chamber.

Furthermore, a motor mounting position for mounting the single output motor and a power source mounting position for mounting a power source are disposed in the first mounting chamber. The positioning piece is located between the motor mounting position and the power source mounting position. The power source electrically connected with the single output motor is disposed at the power source mounting position.

Furthermore, a front end surface of the upper rail may be a rotatable flip cover structure.

Furthermore, an upper connection corner cover is connected respectively between the upper rail and the two side rails, where the upper connection corner covers are a first upper connection corner cover and a second upper connection corner cover. A lower connection corner cover is connected respectively between the lower rail and the two side rails. The lower connection corner covers both are internally provided with a driven wheel mounting position. The first upper connection corner cover is internally and sequentially provided with an input gear mounting position, a transitional gear mounting position and a first drive wheel mounting position, and the second upper connection corner cover is internally provided with a second drive wheel mounting position.

Furthermore, a through hole in communication with the second drive wheel mounting position is disposed on the second upper connection corner cover. The through hole corresponds to the connection hole such that the transmission rod can run through them.

Furthermore, an antenna for receiving signals is disposed in an exposed way on the single output motor. An antenna mounting position for mounting the antenna is disposed inside the first upper connection corner cover. The antenna mounting position is located above the input gear mounting position.

Furthermore, the electric sunshade curtain further comprises two symmetrically-disposed pull ropes, which are a first pull rope and a second pull rope respectively. An upper end of the first pull rope is fixedly connected with the upper rail, and a lower end of the first pull rope runs through the curtain body and then out of the left side of the movable cross beam and then is fixedly connected to one lower connection corner cover or the lower rail below. An upper end of the second pull rope is fixedly connected with the upper rail, and a lower end of the second pull rope runs through the curtain body and then out of the right side of the movable cross beam and then is fixedly connected to the other lower connection corner cover or the lower rail below.

Compared with the prior arts, the present disclosure has the following advantages: In the present disclosure, the transmission rod is connected to one belt assembly through the quick connector, such that the transmission rod can be quickly and cooperatively connected to the other belt assembly after being connected to the one belt assembly, without affecting the horizontal mounting of the movable cross beam. In this way, the mounting difficulty is reduced, the mounting efficiency is increased, and the quick assembling can be achieved. The disposal of the quick connector can not only guarantee no slip of transmission but also reduce the error of the assembling angle, avoiding inclination of the movable cross beam, reducing the rework and increasing the working efficiency.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of the present disclosure.

FIG. 2 is an exploded view of the present disclosure.

FIG. 3 is a structural schematic diagram illustrating a quick connector according to the present disclosure.

FIG. 4 is a structural schematic diagram illustrating a quick connector from another view angle according to the present disclosure.

FIG. 5 is a structural schematic diagram illustrating a second drive wheel according to the present disclosure.

FIG. 6 is a partial schematic diagram illustrating transmission cooperation between a single output motor and a gear assembly according to the present disclosure.

FIG. 7 is a partial schematic diagram illustrating transmission cooperation of a vibration damping assembly added between a single output motor and a gear assembly according to the present disclosure.

FIG. 8 is an exploded view of the vibration damping assembly in FIG. 7.

FIG. 9 is a side view of an upper rail according to the present disclosure.

FIG. 10 is a side view of a flipped-open front end surface of an upper rail according to the present disclosure.

FIG. 11 is a sectional view of a first upper connection corner cover according to the present disclosure.

FIG. 12 is a structural schematic diagram illustrating a second upper connection corner cover according to the present disclosure.

FIG. 13 is a structural schematic diagram illustrating a lower connection corner cover according to the present disclosure.

FIG. 14 is a schematic diagram illustrating cooperation of a positioning piece and an upper rail according to a preferred embodiment of the present disclosure.

FIG. 15 is a side view of FIG. 14.

FIG. 16 is a schematic diagram illustrating cooperation of a positioning piece and an upper rail according to another preferred embodiment of the present disclosure.

FIG. 17 is a structural schematic diagram illustrating pull ropes according to the present disclosure.

Numerals of the drawings are described below: 1. curtain frame, 1.1. upper rail, 1.1.1. first mounting chamber, 1.1.1.1. motor mounting position, 1.1.1.2. power source mounting position, 1.1.2. second mounting chamber, 1.1.3. third mounting chamber, 1.1.4. front end surface, 1.2. lower rail, 1.3 side rail, 1.4 first upper connection corner cover, 1.4.1 input gear mounting position, 1.4.2 transitional gear mounting position, 1.4.3 first drive wheel mounting position, 1.4.4 antenna mounting position, 1.5 second upper connection corner cover, 1.5.1 second drive wheel mounting position, 1.5.2 through hole, 1.6 lower connection corner cover, 1.6.1 driven wheel mounting position, 2. curtain body, 3. movable cross beam, 4. single output motor, 5. transmission rod, 5.1 first end, 5.2 second end, 6. gear assembly, 6.1 input gear, 6.2 output gear, 6.3 transitional gear, 7. belt assembly, 7.1 first drive wheel, 7.1.1 external splines, 7.2 second drive wheel, 7.2.1 connection hole, 7.3 belt, 7.4 driven wheel, 8. quick connector, 8.1 internal splines, 8.2 connection groove, 9. vibration damping assembly, 9.1 input head, 9.1.1 first protrusion block, 9.2 output head, 9.2.1 second protrusion block, 9.3 vibration damping sleeve, 9.3.1 groove, 10. fixing piece, 11. positioning piece, 12. power source, 13. antenna, and 14. pull rope.

### DETAILED DESCRIPTIONS OF EMBODIMENTS

The present disclosure will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

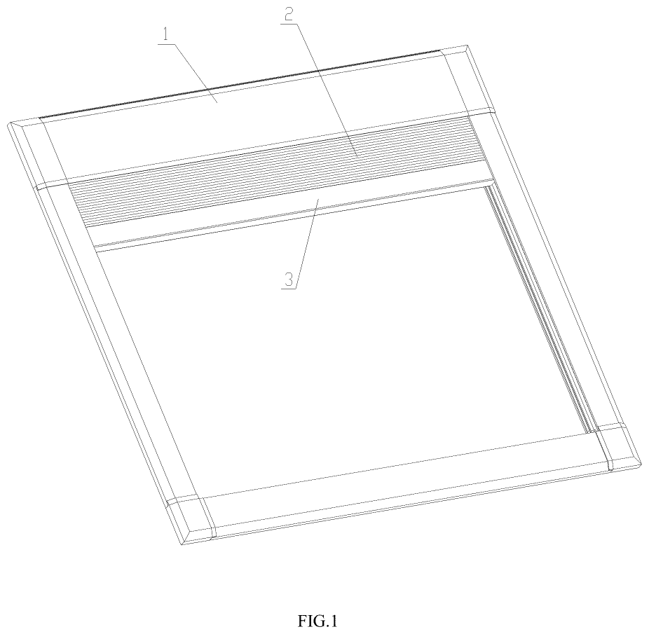

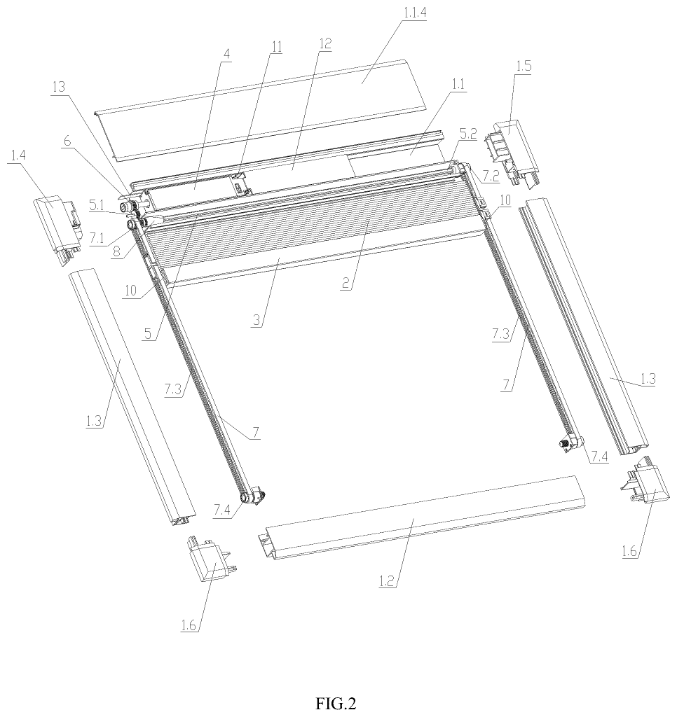

As shown in FIGS. 1 and 2, there is provided a quickly-assembled electric sunshade curtain, which comprises a curtain frame 1. The curtain frame 1 is enclosed by an upper rail 1.1 and a lower rail 1.2 and two side rails 1.3. A curtain body 2 is disposed inside the curtain frame 1. An upper end of the curtain body 2 is fixedly connected to the upper rail 1.1, and a lower end of the curtain body 2 is connected with a movable cross beam 3. The movable cross beam 3 is in slide cooperation with the curtain frame 1 along an opening and closing direction of the curtain body 2. A single output motor 4 and a transmission rod 5 are disposed inside the upper rail 1.1. The single output motor 4 is in transmission cooperation with the transmission rod 5 through a gear assembly 6. The single output motor 4 and the transmission rod 5 are disposed up and down in parallel, so as to avoid mutual interference. A belt assembly 7 is disposed in the side rails 1.3 respectively. The belt assemblies 7 are in transmission connection with the transmission rod 5 and the movable cross beam 3. Through rotation of the belt assemblies 7, the movable cross beam 3 is driven to slide up and down along the curtain frame 1, thus opening and closing the curtain electrically. Opposite first end 5.1 and second end 5.2 are disposed on the transmission rod 5. The first end 5.1 of the transmission rod 5 is connected to the belt assembly 7 at one side through a quick connector 8 and the second end 5.2 of the transmission rod 5 is connected to the belt assembly 7 at the other side.

In the present disclosure, the transmission rod 5 is connected to one belt assembly 7 through the quick connector 8, such that the transmission rod 5 can be quickly and cooperatively connected to the other belt assembly 7 after being connected to the one belt assembly 7, without affecting the horizontal mounting of the movable cross beam 3. In this way, the mounting difficulty is reduced, the mounting efficiency is increased, and the quick assembling can be achieved. The disposal of the quick connector 8 can not only guarantee no slip of transmission but also reduce the error of the assembling angle, avoiding inclination of the movable cross beam 3, reducing the rework and increasing the working efficiency. Furthermore, the single output motor 4 is used to replace the original dual-output motor, reducing the costs.

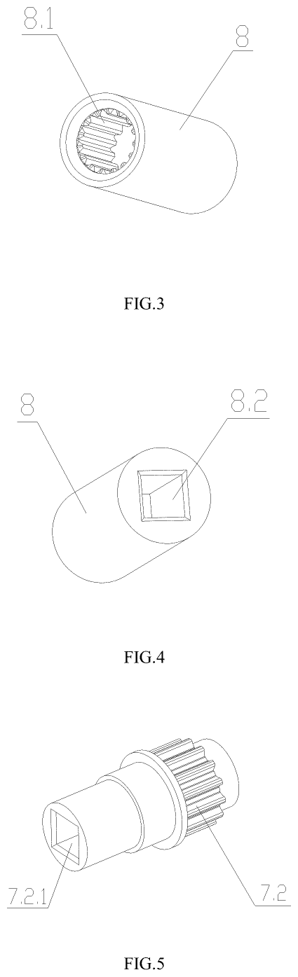

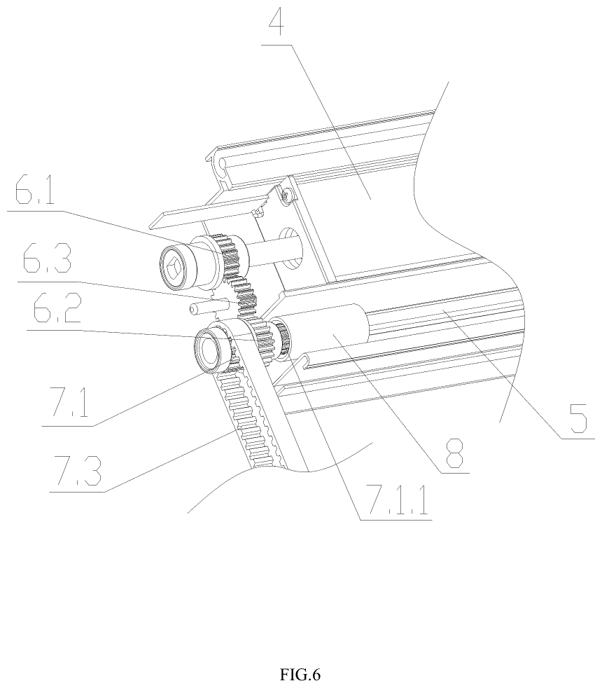

As shown in FIGS. 2 to 6, the belt assemblies 7 comprise a drive wheel, a belt 7.3, and a driven wheel 7.4. Both ends of the belt 7.3 are sleeved on the drive wheel and the driven wheel 7.4 respectively. The drive wheel is disposed at an upper end of the side rails 1.3 and the driven wheel 7.4 is disposed at a lower end of the side rails 1.3. The first end 5.1 of the transmission rod 5 is connected to the drive wheel of the belt assembly 7 at one side through the quick connector 8, where the drive wheel is a first drive wheel 7.1. The second end 5.2 of the transmission rod 5 is connected to the drive wheel of the belt assembly 7 at the other side, where the drive wheel is a second drive wheel 7.2. External splines 7.1.1 are integrally formed on the first drive wheel 7.1, and internal splines 8.1 matching the external splines 7.1.1 are disposed at an end of the quick connector 8. It is to be noted that, the positions of the internal splines and the external splines may be exchanged. Preferably, as shown in the preceding structure, quick insertion can be easily achieved without carefully aligning. A connection groove 8.2 in connection with the transmission rod 5 is disposed at the other end of the quick connector 8. A connection hole 7.2.1 in connection with the transmission rod 5 is disposed on the second drive wheel 7.2. The connection hole 7.2.1 is provided for the transmission rod 5 to run through. During assembling, the first end 5.1 of the transmission rod 5 is run through the connection hole 7.2.1 and then inserted into the connection groove 8.2 of the quick connector 8, and then the internal splines of the quick connector 8 are connected, in an insertion manner, with the external splines 7.1.1 on the first drive wheel 7.1, thus achieving quick assembling without taking time to calibrate the angle. In this way, the angle error is reduced, and thus the movable cross beam 3 will not be inclined due to the angle error. Taking as an example one transmission rod with a section as square, in case of no quick connector, the first drive wheel and the second drive wheel both are provided with a connection hole matching the sectional shape of the transmission rod. When the transmission rod is inserted through the connection hole of the second drive wheel, it should be guaranteed that the connection hole of the first drive wheel fully corresponds in direction to the connection hole of the second drive wheel, and otherwise, even with a tiny error, the transmission rod cannot be smoothly inserted into the connection hole of the first drive wheel. At this time, the movable cross beam below has already been leveled and mounted. If the transmission rod cannot be smoothly aligned and inserted, it is required to re-adjust the belt assemblies at both sides to ensure the movable cross beam is horizontally mounted and the connection hole of the first drive wheel also fully corresponds to the connection hole of the second drive wheel. The “fully correspond” herein refers to that when the first drive wheel and the second drive wheel are axially attached to each other, the connection holes will be fully overlapped without any angle error. Therefore, the existing structure is mounted with high difficulty. With the disposal of the quick connector 8, the internal spines 8.1 cooperate with the external splines 7.1.1 to enable the peripheral assembling structure to be indefinitely approximate to a cylindrical structure. Even if the transmission rod 5 has an angle error after running through the connection hole 7.2.1 of the second drive wheel 7.2, the transmission rod 5 can be still connected with the quick connector 8, thus greatly reducing the mounting difficulty and the rework. The first drive wheel 7.1 and the second drive wheel 7.2 rotate in synchronization with the transmission rod 5. The connection groove 8.2, the connection hole 7.2.1 have the same sectional shape as the transmission rod 5, for example, regular quadrangle, regular pentagon and regular hexagon and the like. In this way, it is guaranteed that the transmission rod 5 can drive the quick connector 8, the second drive wheel 7.2 and the first drive wheel 7.1.

As shown in FIGS. 2, 6 and 11, the single output motor 4 is disposed at an end of the upper rail 1.1 and is close to the first end 5.1 of the transmission rod 5. The gear assembly 6 comprises an input gear 6.1, and an output gear 6.2. The input gear 6.1 is in engagement transmission with the output gear 6.2. An output end of the single output motor 4 is in transmission connection with the input gear 6.1, the first end 5.1 of the transmission rod 5 is in transmission cooperation with the output gear 6.2, and the output gear 6.2 is in transmission cooperation with the first drive wheel 7.1. Specifically, the output gear 6.2 may be in coaxial connection with the first drive wheel 7.1 for synchronous rotation, or the output gear 6.2 and the first drive wheel 7.1 are integrally formed, where the output gear 6.2 is formed between the first drive wheel 7.1 and the external splines 7.1.1. The external splines 7.1.1 are docked with the internal splines 8.1 of the quick connector 8. The connection groove 8.2 of the quick connector 8 is connected with the first end 5.1 of the transmission rod 5 in a sleeving manner. The single output motor 4 outputs power to drive the rotation of the input gear 6.1, and the input gear 6.1 then drives the output gear 6.2. The output gear 6.2 is integrally formed together with the first drive wheel 7.1 and the external splines 7.1.1 and thus can rotate together with the first drive wheel 7.1 and the external splines 7.1.1. The external splines 7.1.1 drive the quick connector 8, and then the quick connector 8 drives the transmission rod 5 and then the transmission rod 5 drives the second drive wheel 7.2 and then the second drive wheel 7.2 drives the belt 7.3 and the first drive wheel 7.1 drives the other belt 7.3. Thus, the movable cross beam 3 can be slid in a horizontal state up and down to open and close the curtain. As a result, the gear assembly 6 achieves the effects of not only conveying the power but also reducing the speed as well as the effect of changing the power conveying direction.

The gear assembly 6 further comprises at least one transitional gear 6.3. The transitional gear 6.3 is engaged between the input gear 6.1 and the output gear 6.2. The disposal of the transitional gear 6.3 can further achieve the effect of deceleration and can adapt to an up-down distance between the single output motor 4 and the transmission rod 5. When the up-down distance between the single output motor 4 and the transmission rod 5 is large, a plurality of transitional gears 6.3 may be mounted, which is dependent on the specific actual structure. In the drawing, there is only one transitional gear 6.3 added.

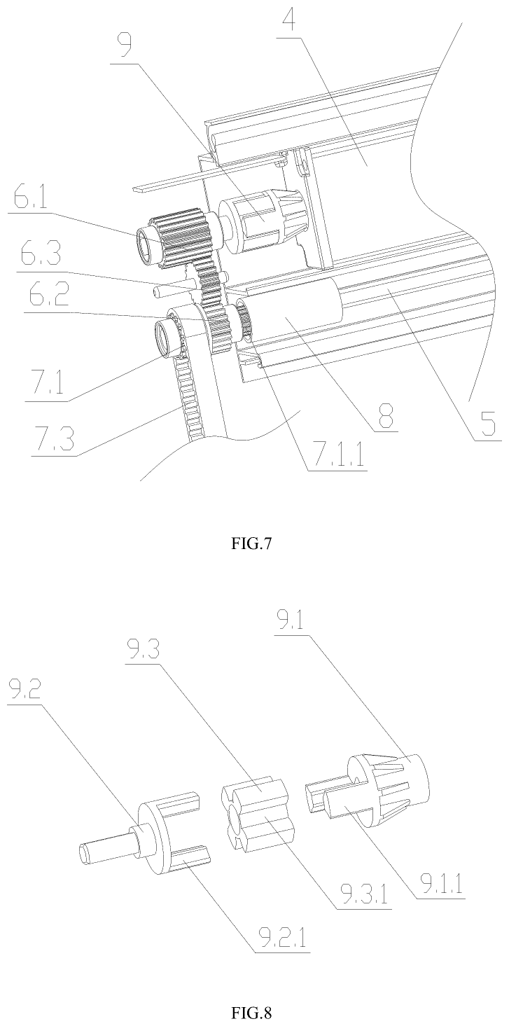

As shown in FIGS. 7 and 8, for the purpose of reducing the working noise of the single output motor 4, a vibration damping assembly 9 is connected between the output end of the single output motor 4 and the input gear 6.1. The vibration damping assembly 9 comprises an input head 9.1, an output head 9.2, and a vibration damping sleeve 9.3. The input head 9.1 is connected with the output end of the single output motor 4, the output head 9.2 is connected with the input gear 6.1, and the vibration damping sleeve 9.3 is connected between the input head 9.1 and the output head 9.2 to prevent the input head 9.1 from being in direct contact with the output head 9.2. The vibration damping sleeve 9.3 is a flexible vibration damping sleeve. As a result, the vibration damping assembly 9 can be added between the output end of the single output motor 4 and the input gear 6.1 to reduce the noise. Further, one vibration damping sleeve 9.3 is transitioned between the output head 9.2 and the input head 9.1 in the vibration damping assembly 9 to not only achieve power transmission but also change hard connection into soft connection, thus reducing both vibration and noise. The hard connection refers to direct connection between parts of non-flexible materials, which generates large noise, whereas the soft connection refers to transitional connection of flexible materials added between the parts of non-flexible materials, damping the vibration and reducing the noise.

Symmetrically-disposed first protrusion blocks 9.1.1 extend from an end of the input head 9.1 facing toward the vibration damping sleeve 9.3, and symmetrically-disposed second protrusion blocks 9.2.1 extend from an end of the output head 9.2 facing toward the vibration damping sleeve 9.3. The vibration damping sleeve 9.3 is provided with grooves 9.3.1 for alternately inserting the first protrusion blocks 9.1.1 and the second protrusion blocks 9.2.1. A length of the grooves 9.3.1 is greater than a length of the first protrusion blocks 9.1.1 and the second protrusion blocks 9.2.1. The first protrusion blocks 9.1.1 and the second protrusion blocks 9.2.1 cooperate alternately with the grooves 9.3.1 on the vibration damping sleeve 9.3, such that the transmission force is more balanced and the transmission is more stable. Furthermore, since the length of the grooves 9.3.1 is greater than the length of the first protrusion blocks 9.1.1 and the second protrusion blocks 9.2.1, it is guaranteed that the input head 9.1 and the output head 9.2 are fully out of contact, achieving the power transmission of the soft connection, damping the vibration and reducing the noise.

With reference to FIG. 2, both ends of the movable cross beam 3 are fixedly connected to the belts 7.3 at both sides through fixing pieces 10. The movable cross beam 3 can rotate in synchronization with the belts 7.3 at both sides, and thus it is ensured that the movable cross beam 3 can slide up and down in a horizontal state, avoiding light leakage due to inclination.

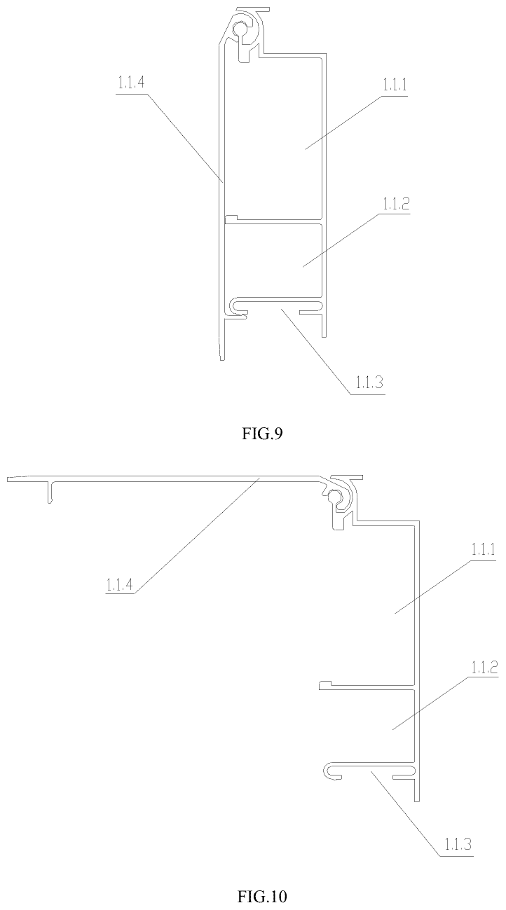

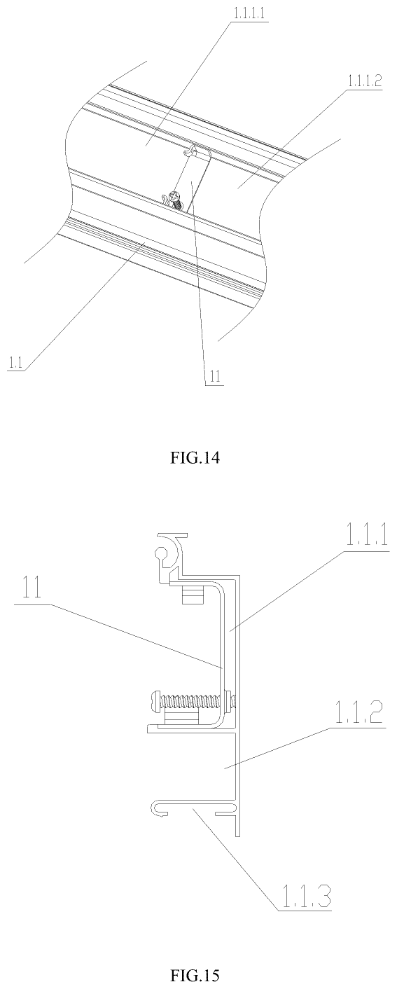

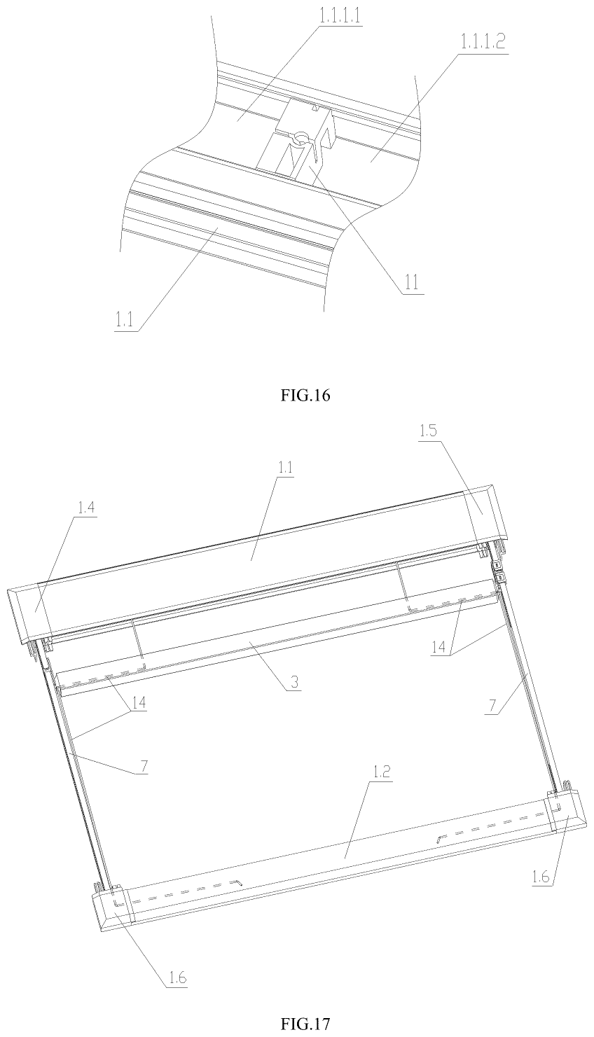

With reference to FIGS. 2 and 9, a first mounting chamber 1.1.1, a second mounting chamber 1.1.2 and a third mounting chamber 1.1.3 are disposed in sequence inside the upper rail 1.1 from top down. The first mounting chamber 1.1.1 is used to mount the single output motor 4, the second mounting chamber 1.1.2 is used to mount the transmission rod 5, and the third mounting chamber 1.1.3 is used to mount an upper end of the curtain body 2. A positioning piece 11 for limiting the single output motor 4 is disposed at the opposed end of the output end of the single output motor 4 inside the first mounting chamber 1.1.1. The disposal of the positioning piece 11 can prevent the axial slide of the single output motor 4 and thus achieve the limiting and fixing effect. As a preferred example, as shown in FIG. 16, the positioning piece 11 may be a fixing block on which an expansion hole (not shown) for inserting a screw is disposed. During assembling process, the fixing block is slid into the first mounting chamber 1.1.1 and placed at the tail of the single output motor 4 for prepositioning, and then a screw is inserted into the expansion hole to enable the fixing block to expand toward both sides of the first mounting chamber 1.1.1 until the fixing block is abutted against both sides of the first mounting chamber 1.1.1 and fixedly supported inside the first mounting chamber 1.1.1, thereby achieving axial limitation for the single output motor 4. This structure eliminates the need of opening a screw hole in the first mounting chamber 1.1.1, thus reducing damage to the upper rail 1.1 and presenting more aesthetic structural appearance. As another preferred example, with reference to FIGS. 14 and 15, the positioning piece 11 is a fixing sheet on which a screw hole is opened. During mounting process, the fixing sheet is slid into the first mounting chamber 1.1.1 and placed at the tail of the single output motor 4 for prepositioning, and then a screw is inserted into the screw hole. Along with rotation of the screw, the fixing sheet is moved upward along the screw until the fixing sheet is closely abutted or clamped against an edge of the first mounting chamber 1.1.1. The abutting structure may be that an end of a folding edge of the fixing sheet is abutted against a stepped surface of the edge of the first mounting chamber 1.1.1. The clamping structure may be that a clamping position is disposed on the edge of the first mounting chamber 1.1.1 and a catch fitted into the clamping position is disposed on the fixing sheet, such that the fixing sheet is fixed in the first mounting chamber 1.1.1, thus achieving axial limitation for the single output motor 4. This structure eliminates the need of opening a screw hole in the first mounting chamber 1.1.1, reducing the damage to the upper rail 1.1 and presenting more aesthetic structural appearance.

With reference to FIGS. 2, 14 and 16, a motor mounting position 1.1.1.1 for mounting the single output motor 4 and a power source mounting position 1.1.1.2 for mounting a power source 12 are disposed in the first mounting chamber 1.1.1. The positioning piece 11 is located between the motor mounting position 1.1.1.1 and the power source mounting position 1.1.1.2. The power source 12 electrically connected with the single output motor 4 is disposed in the power source mounting position 1.1.1.2. The disposal of the above structure achieves high space utilization rate and structural compactness. Further, the power source 12 and the single output motor 4 are difficult to slide or displace freely, and do not have mutual interference.

With reference to FIGS. 2, 9 and 10, for ease of mounting, repairing and changing the power source 12 and the single output motor 4, a front end surface 1.1.4 of the upper rail 1.1 may be a rotatable flip cover structure, providing conveniences of opening, closing and use. As a preferred flip cover structure, the top of the upper rail 1.1 is provided with a hinging shaft and the top of the front end surface 1.1.4 is provided with a hinging groove rotatably cooperating with the hinging shaft. Through the hinging cooperation of the hinging shaft and the hinging groove, the front end surface 1.1.4 can be flipped, bringing conveniences to the opening and closing operation. It is to be noted that the positions of the hinging groove and the hinging shaft can be exchanged and thus are not limited herein. Furthermore, the flip cover structure may also be implemented by another hinging structure or a magnetic attraction structure as long as the front end surface 1.1.4 can be opened and closed in a flipping way.

With reference to FIGS. 1, 2, 11, 12, and 13, an upper connection corner cover is connected respectively between the upper rail 1.1 and the two side rails 1.3, where the upper connection corner covers are a first upper connection corner cover 1.4 and a second upper connection corner cover 1.5. A lower connection corner cover 1.6 is connected respectively between the lower rail 1.2 and the two side rails 1.3. The lower connection corner covers 1.6 both are internally provided with a driven wheel mounting position 1.6.1. The first upper connection corner cover 1.4 is internally and sequentially provided with an input gear mounting position 1.4.1, a transitional gear mounting position 1.4.2 and a first drive wheel mounting position 1.4.3, and the second upper connection corner cover 1.5 is internally provided with a second drive wheel mounting position 1.5.1. The upper connection corner covers and the lower connection corner covers are positioned in such a way that the curtain frame 1 and other parts can be easily assembled.

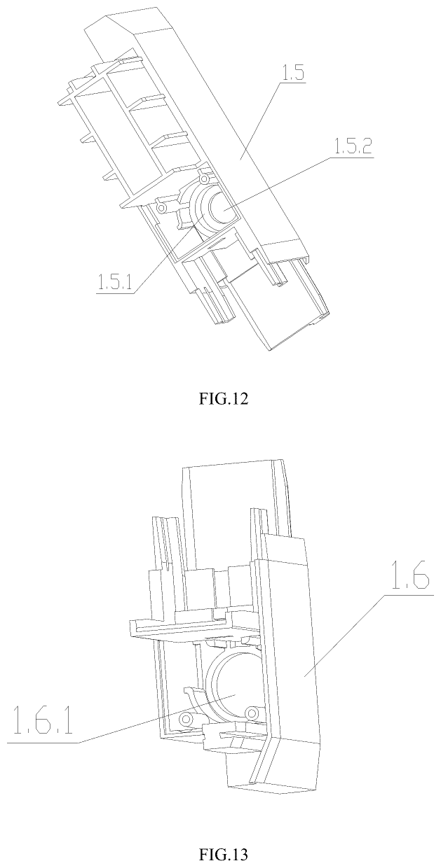

With reference to FIG. 12, a through hole 1.5.2 in communication with the second drive wheel mounting position 1.5.1 is disposed on the second upper connection corner cover 1.5. The through hole 1.5.2 corresponds to the connection hole 7.2.1 such that the transmission rod 5 can run through them. The shape of the through hole 1.5.2 is preferably circular to help the transmission rod 5 to quickly run through the through hole. Further, the through hole 1.5.2 is larger than the connection hole 7.2.1 such that the transmission rod 5 can quickly run through the connection hole 7.2.1 after running through the through hole 1.5.2.

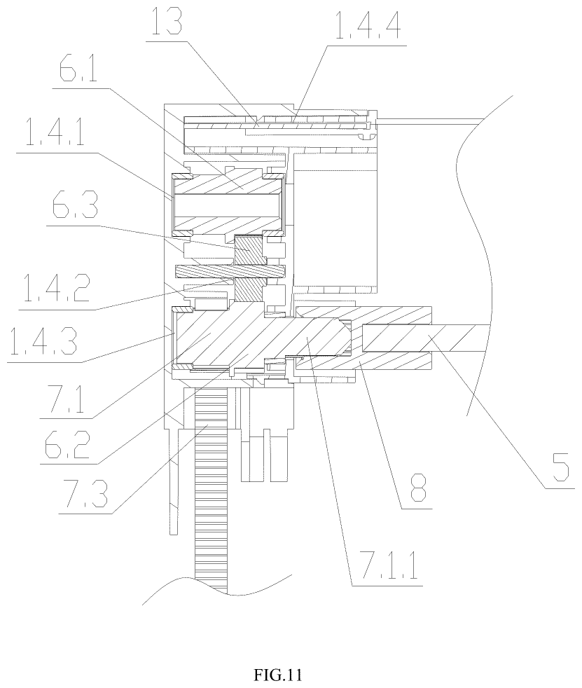

With reference to FIGS. 2 and 11, an antenna 13 for receiving signals is disposed in an exposed way on the single output motor 4. An antenna mounting position 1.4.4 for mounting the antenna 13 is disposed inside the first upper connection corner cover 1.4. The antenna mounting position 1.4.4 is located above the input gear mounting position 1.4.1. Preferably, the antenna 13 is a PCB board antenna which is disposed inside the first upper connection corner cover 1.4 to better receive signals. Further, the mounting position of the antenna 13 is structurally compact and thus the mounting space of the first upper connection corner cover 1.4 can be better utilized. Moreover, the first upper connection corner cover 1.4 is made of a non-conductive material, and thus is safe and unable to shield the signals.

With reference to FIG. 17, the electric sunshade curtain further comprises two symmetrically-disposed pull ropes, which are a first pull rope and a second pull rope respectively. An upper end of the first pull rope is fixedly connected with the upper rail 1.1, and a lower end of the first pull rope runs through the curtain body 2 and then out of the left side of the movable cross beam 3 and then is fixedly connected to one lower connection corner cover 1.6 or the lower rail 1.2 below. An upper end of the second pull rope is fixedly connected with the upper rail 1.1, and a lower end of the second pull rope runs through the curtain body 2 and then out of the right side of the movable cross beam 3 and then is fixedly connected to the other lower connection corner cover 1.6 or the lower rail 1.2 below. Corresponding rope fixing positions are disposed on the lower rail 1.2, and pull rope fixing holes are disposed on both of the lower connection corner covers 1.6. The manner of fixing the pull ropes 14 can be selected based on specific actual assembling structure. As shown in FIG. 17, the lower ends of the pull ropes 14 are fixed on the lower rail 1.2 for example, and the disposal of the pull ropes 14 can support the curtain body 2 to prevent collapse or droop of the curtain body 2 during opening and closing process. The curtain body 2 can be opened and closed more smoothly along the pull ropes 14.

During an assembling process, the curtain frame 1, the single output motor 4, the vibration damping assembly 9, the gear assembly 6, the belt assembly 7, the curtain body 2, the pull ropes 14, and the movable cross beam 3 and the like are all mounted, and then the movable cross beam 3 is adjusted to be in a horizontal state, and then the first end 5.1 of the transmission rod 5 is sequentially penetrated from a side of the curtain frame 1 through the through hole 1.5.2 and the connection hole 7.2.1, and then inserted into the connection groove 8.2 of the quick connector 8, and then the internal splines 8.1 of the quick connector 8 are sleeved on the external splines 7.1.1, so as to achieve quick mounting of the transmission rod 5 without affecting the horizontal state of the movable cross beam 3, thus avoiding light leakage due to inclination of the movable cross beam 3. With the transitional disposal of the quick connector 8, the cooperation structure of the internal splines 8.1 and the external splines 7.1.1 can reduce the angle error to a negligible level, thereby achieving quick assembling, reducing the rework and increasing the working efficiency. When the curtain works, the single output motor 4 conveys power to the vibration damping assembly 9 through the output end, the vibration damping assembly 9 drives the input gear 6.1, and the input gear 6.1 sequentially drives the transitional gear 6.3 and the output gear 6.2, and then the output gear 6.2 drives the first drive wheel 7.1 and the external splines 7.1.1 to rotate synchronously, and then the external splines 7.1.1 drives the quick connector 8, and then the quick connector 8 drives the transmission rod 5 and then the transmission rod 5 drives the second drive wheel 7.2 and thus the first drive wheel 7.1 and the second drive wheel 7.2 drives the rotation of the corresponding belts 7.3 respectively, and then the belts 7.3 at both sides drive the movable cross beam 3 in the horizontal state to slide up and down along an opening and closing direction of the curtain body 2, thus opening and closing the curtain body 2. In addition, it is noted that when the present disclosure is mounted to a building, it can be mounted upward, namely, the upper rail 1.1 is located above and the lower rail 1.2 is located below and thus the curtain body 2 unfolds from top down to block light and folds from bottom up to let light in; the present disclosure may also be mounted downward, namely, the upper rail 1.1 is located below and the lower rail 1.2 is located above, and thus the curtain body 2 unfolds from bottom up to block light and folds from top down to let light in; the present disclosure may also be mounted sideward, namely, the upper rail 1.1 is located at the left side and the lower rail 1.2 is located at the right side, and thus the curtain body 2 unfolds from left to right to block light and folds from right to left to let light in; or the upper rail 1.1 is located at the right side and the lower rail 1.2 is located at the left side, and thus the curtain body 2 unfolds from right to left to block light and folds from left to right to let light in. The mounting direction can be selected based on the use habits of the people.

The materials, reagents and experimental apparatuses involved in the embodiments of the present disclosure all are commercially available products in the electric sunshade curtain field unless otherwise stated.

Finally, it should be noted that the above embodiments are used only to describe the technical solution of the present disclosure rather than to limit the present disclosure. Although detailed descriptions are made to the present disclosure by referring to the preceding embodiments, those skilled in the art should understand that modifications can be made to the technical solutions recorded in the above embodiments or equivalent substitutions can be made to partial technical features therein. These modifications or substitutions will not cause the essence of the corresponding technical solutions to depart from the spirit and scope of the technical solutions of the embodiments of the present disclosure.

1. A quickly-assembled electric sunshade curtain, comprising a curtain frame (1), and the curtain frame (1) is enclosed by an upper rail (1.1), a lower rail (1.2), and two side rails (1.3); a curtain body (2) is disposed inside the curtain frame (1); an upper end of the curtain body (2) is fixedly connected with the upper rail (1.1), and a lower end of the curtain body (2) is connected with a movable cross beam (3); the movable cross beam (3) slidably cooperates with the curtain frame (1) along an opening and closing direction of the curtain body (2); wherein a single output motor (4) and a transmission rod (5) are disposed inside the upper rail (1.1); the single output motor (4) is in transmission cooperation with the transmission rod (5) through a gear assembly (6); the single output motor (4) and the transmission rod (5) are disposed up and down in parallel; a belt assembly (7) is disposed in the side rails (1.3) respectively, and the belt assemblies (7) are in transmission connection with the transmission rod (5) and the movable cross beam (3); the transmission rod (5) has opposed first end (5.1) and second end (5.2); the first end (5.1) of the transmission rod (5) is connected to the belt assembly (7) at one side through a quick connector (8) and the second end (5.2) of the transmission rod (5) is connected to the belt assembly (7) at the other side.

2. The quickly-assembled electric sunshade curtain of claim 1, wherein the belt assembly (7) comprises a drive wheel, a belt (7.3) and a driven wheel (7.4); two ends of the belt (7.3) are sleeved on the drive wheel and the driven wheel (7.4) respectively; the drive wheel is disposed at an upper end of the side rails (1.3) and the driven wheel (7.4) is disposed at a lower end of the side rails (1.3); the first end (5.1) of the transmission rod (5) is connected through the quick connector (8) to the drive wheel of the belt assembly (7) at one side, and the drive wheel is a first drive wheel (7.1); the second end (5.2) of the transmission rod (5) is connected to the drive wheel of the belt assembly (7) at the other side, and the drive wheel is a second drive wheel (7.2); external splines (7.1.1) are integrally formed on the first drive wheel (7.1); internal splines (8.1) cooperating with the external splines (7.1.1) are disposed on one end of the quick connector (8), and a connection groove (8.2) connected with the transmission rod (5) is disposed on the other end of the quick connector (8); a connection hole (7.2.1) connected with the transmission rod (5) is disposed on the second drive wheel (7.2); the first drive wheel (7.1) and the second drive wheel (7.2) can rotate in synchronization with the transmission rod (5).

3. The quickly-assembled electric sunshade curtain of claim 2, wherein the single output motor (4) is disposed at an end of the upper rail (1.1) and is close to the first end (5.1) of the transmission rod (5); the gear assembly (6) comprises an input gear (6.1) and an output gear (6.2); the input gear (6.1) is in engagement transmission with the output gear (6.2); the output end of the single output motor (4) is in transmission connection with the input gear (6.1); the first end (5.1) of the transmission rod (5) is in transmission cooperation with the output gear (6.2), and the output gear (6.2) is in transmission cooperation with the first drive wheel (7.1).

4. The quickly-assembled electric sunshade curtain of claim 3, wherein the gear assembly (6) further comprises at least one transitional gear (6.3); the transitional gear (6.3) is engaged between the input gear (6.1) and the output gear (6.2), and the output gear (6.2) and the first drive wheel (7.1) are integrally formed.

5. The quickly-assembled electric sunshade curtain of claim 3, wherein a vibration damping assembly (9) is connected between the output end of the single output motor (4) and the input gear (6.1); the vibration damping assembly (9) comprises an input head (9.1), an output head (9.2) and a vibration damping sleeve (9.3); the input head (9.1) is connected with the output end of the single output motor (4); the output head (9.2) is connected with the input gear (6.1); the vibration damping sleeve (9.3) is connected between the input head (9.1) and the output head (9.2) to prevent the input head (9.1) from being in direct contact with the output head (9.2); the vibration damping sleeve (9.3) is a flexible vibration damping sleeve.

6. The quickly-assembled electric sunshade curtain of claim 5, wherein symmetrically-disposed first protrusion block (9.1.1) extending from an end of the input head (9.1) facing toward the vibration damping sleeve (9.3), and symmetrically-disposed second protrusion block (9.2.1) extending from an end of the output head (9.2) facing toward the vibration damping sleeve (9.3); the vibration damping sleeve (9.3) is provided with a groove (9.3.1) for alternately inserting the first protrusion block (9.1.1) and the second protrusion block (9.2.1); a length of the groove (9.3.1) is greater than a length of the first protrusion block (9.1.1) and the second protrusion block (9.2.1).

7. The quickly-assembled electric sunshade curtain of claim 2, wherein both ends of the movable cross beam (3) are fixedly connected to the belts (7.3) at both sides through fixing pieces (10); the movable cross beam (3) can rotate in synchronization with the belts (7.3) at both sides.

8. The quickly-assembled electric sunshade curtain of claim 3, wherein a first mounting chamber (1.1.1), a second mounting chamber (1.1.2) and a third mounting chamber (1.1.3) are disposed in sequence inside the upper rail (1.1) from top down; the first mounting chamber (1.1.1) is used to mount the single output motor (4); the second mounting chamber (1.1.2) is used to mount the transmission rod (5), and the third mounting chamber (1.1.3) is used to mount an upper end of the curtain body (2); a positioning piece (11) for limiting the single output motor (4) is disposed at the opposed end of the output end of the single output motor (4) inside the first mounting chamber (1.1.1).

9. The quickly-assembled electric sunshade curtain of claim 8, wherein a motor mounting position (1.1.1.1) for mounting the single output motor (4) and a power source mounting position (1.1.1.2) for mounting a power source (12) are disposed in the first mounting chamber (1.1.1); the positioning piece (11) is located between the motor mounting position (1.1.1.1) and the power source mounting position (1.1.1.2); the power source (12) is disposed at the power source mounting position (1.1.1.2), and the single output motor (4) is electrically connected with the power source (12).

10. The quickly-assembled electric sunshade curtain of claim 9, wherein a front end surface (1.1.4) of the upper rail (1.1) is a rotatable flip cover structure.

11. The quickly-assembled electric sunshade curtain of claim 4, wherein an upper connection corner cover is connected respectively between the upper rail (1.1) and the two side rails (1.3), and the upper connection corner covers are a first upper connection corner cover (1.4) and a second upper connection corner cover (1.5); a lower connection corner cover (1.6) is connected respectively between the lower rail (1.2) and the two side rails (1.3); the lower connection corner covers (1.6) both are internally provided with a driven wheel mounting position (1.6.1); the first upper connection corner cover (1.4) is internally and sequentially provided with an input gear mounting position (1.4.1), a transitional gear mounting position (1.4.2) and a first drive wheel mounting position (1.4.3), and the second upper connection corner cover (1.5) is internally provided with a second drive wheel mounting position (1.5.1).

12. The quickly-assembled electric sunshade curtain of claim 11, wherein a through hole (1.5.2) in communication with the second drive wheel mounting position (1.5.1) is disposed on the second upper connection corner cover (1.5); the through hole (1.5.2) corresponds to the connection hole (7.2.1) so that the transmission rod (5) can run through them.

13. The quickly-assembled electric sunshade curtain of claim 11, wherein an antenna (13) for receiving signals is disposed in an exposed way on the single output motor (4); an antenna mounting position (1.4.4) for mounting the antenna (13) is disposed inside the first upper connection corner cover (1.4); the antenna mounting position (1.4.4) is located above the input gear mounting position (1.4.1).

14. The quickly-assembled electric sunshade curtain of claim 11, wherein the electric sunshade curtain further comprises two symmetrically-disposed pull ropes (14), which are a first pull rope and a second pull rope respectively; an upper end of the first pull rope is fixedly connected with the upper rail (1.1), and a lower end of the first pull rope runs through the curtain body (2) and then out of the left side of the movable cross beam (3) and then is fixedly connected to one lower connection corner cover (1.6) or the lower rail (1.2) below; an upper end of the second pull rope is fixedly connected with the upper rail (1.1), and a lower end of the second pull rope runs through the curtain body (2) and then out of the right side of the movable cross beam (3) and then is fixedly connected to the other lower connection corner cover (1.6) or the lower rail (1.2) below.
